(19) United States
(12) Patent Application Publication
(10) Pub. No.: US 2003/0200441 A1
(43) Pub. Date: Oct. 23, 2003

(54) Detecting randomness in computer network traffic

(75) Inventors: Clark Debs Jeffries, Durham, NC (US); Wuchieh James Jong, Raleigh, NC (US); Grayson Warren Randall, Cary, NC (US); Ken Van Vu, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/127,031

(22) Filed: Apr. 19, 2002

(51) Int. Cl. G06F 11/30; G06F 15/173

(52) U.S. Cl. 713/181; 713/201; 709/224

(57) ABSTRACT

A method, system and computer program product for detecting denial-of-service attacks. The randomness in the Internet Protocol (IP) source addresses of transmitted IP packets may be detected by performing a hash function on the IP source addresses thereby generating one or more different hash values. If a high number of different hash values were generated for a small number of IP packets evaluated, then random IP source addresses may be detected. By detecting random source IP addresses, a denial-of-service attack may be detected.

### TECHNICAL FIELD

The present invention relates to the field of a denial-of-service attacks, and more particularly to detecting randomness in Internet Protocol (IP) source addresses in order to detect a denial-of-service attack.

### BACKGROUND INFORMATION

A denial-of-service attack may refer to an assault on a network device, e.g., server, that floods it with so many additional requests that regular traffic is either slowed or completely interrupted. These additional requests may be spurious requests transmitted over the Internet with the purpose of consuming the resources of the network device that would otherwise be used for legitimate users. The Internet includes use of a suite of communication protocols known as Transmission Control Protocol/Internet Protocol (TCP/IP) which sends packets of data between the network device, e.g., server, and computers commonly referred to as client machines.

One example of a denial-of-service attack is commonly referred to as the “SYN flood” attack. It is noted that there are other examples of denial-of-service attacks such as a smurf attack, Ping of Death, etc., but these are not discussed for sake of brevity. In a SYN flood attack, a flood of TCP SYN (Transmission Control Protocol SYNchronize) packets may be transmitted over the Internet to a victim network device, e.g., server, by a user commonly referred to as an attacker. For each such SYN packet received, the victim device, e.g., server, must allocate a new data structure for the connection. However, the number of these new data structures may be limited by the victim's operating system. Consequently, the victim may be overloaded causing the victim to process the packets at a slower rate, not process legitimate SYN requests, or even crash.

An attacker may use multiple computers throughout the network in order to increase the severity of the attack. A denial-of-service attack that uses multiple computers throughout the network may commonly be referred to as a distributed denial-of-service attack. In such a case, the attacker may install a small attack daemon on these other client machines thereby producing a group of “zombie” clients. This daemon typically contains both the code for sourcing a variety of attacks and some basic communication infrastructure to allow for remote control.

The attacker may conceal its location by forging or “spoofing” the Internet Protocol (IP) source address of each packet they send. Spoofing may refer to replacing the source address of the sender with a random source IP address thereby concealing the location of the attacker. Consequently, the packets appear to the victim network device, e.g., server, to be arriving from one or more third parties. For example, in a distributed denial-of-service attack using the SYN flood attack as discussed above, the attacker may transmit a series of SYN packets to the victim, e.g., server, using a series of random spoofed source addresses. Upon receiving these packets, the victim may respond by sending SYN/ACK (SYNchornize-ACKnowledge) responses to each of the spoofed computers.

Currently, there are no technological means for statistically detecting a denial-of-service attack. However, since attackers commonly spoof the source IP address field to conceal the location of the attacking client, a denial-of-service attack may be observed by detecting the randomness of the source IP addresses passing a given point in a network.

It would therefore be desirable to detect the randomness in Internet Protocol (IP) source addresses in order to detect a denial-of-service attack.

### SUMMARY

The problems outlined above may at least in part be solved in some embodiments by detecting the randomness in the Internet Protocol (IP) source addresses of received IP packets. In one embodiment, the randomness in the IP source addresses may be detected by performing a hash function on the IP source addresses thereby generating one or more different hash values. If a high number of different hash values were generated for a small number of IP packets evaluated, then random IP source address may be detected. By detecting random source IP addresses, a denial-of-service attack may be detected.

In one embodiment of the present invention, a method for detecting a denial-of-service attack may comprise the step of a router at the edge of a subnet receiving an Internet Protocol (IP) packet of data from a client either within the subnet or externally from the subnet. The IP packet received by the router may contain a random spoofed source address.

It may then be determined by the router if the received packet is being forwarded to an external network, e.g., Internet, outside the subnet. If the received packet is determined to be forwarded to an external network, e.g., Internet, then the following steps may occur for each received IP packet to be forwarded to the external network.

The router may perform a hash function on the source address, e.g., 32-bits long, of the received IP packet to generate a hash value, e.g., 8-bit value. In one embodiment, the hash function may be a function that transforms a subset of the source address to a hash value if the number n bits of the source address, e.g., most significant bits of the source address, is greater than or equal to the number m bits, e.g., number of bits of the hash value. Hence, the hash value may equal n bits of the source address, e.g., hash value may equal the most significant bits of the source address. Furthermore, the hash function may not necessarily change the order of the n bits of the source address in transforming the n bits of the source address to the m bits of the hash value.

The hash value generated may then be indexed into a table or associative array where each entry may correspond to a particular hash value. The corresponding entry in the table or associative array may be marked as occupied, e.g., a “1” bit value may be stored, if the entry is not already marked as occupied. An unoccupied entry may store the complement of the value stored in entries marked as occupied, e.g., a “0” bit. A counter, which may be implemented in either software or hardware in the router, may be incremented by one to indicate the number of packets examined.

A determination may then be made as to whether the predetermined number of packets, e.g., one thousand packets to be forwarded to the external network, has been examined. In one embodiment, whether the predetermined number of packets has been examined may be determined by the value of the counter as described above. If less than the predetermined number of packets has been examined, then the router may receive another IP packet as described above.

If the predetermined number of packets, e.g., one thousand packets to be forwarded to the external network, has been examined by the router, then the router may determine the number of different hash values generated from performing the hash function on the IP source addresses of the predetermined number of packets. In one embodiment, the number of different hash values generated from performing the hash function on the IP source addresses of the predetermined number of packets may be determined by counting the number of entries in the table marked as being occupied.

A determination may then be made as to whether the number of different hash values generated is less than the following:

F*2\hat{ }B

where F is a predetermined fraction, e.g., ¼, and B is a number of bits of the hash value, e.g., 8-bits.

For example, if F has a value of ¼ and the hash values generated by the hash function were 8-bits long, then F*2\hat{ }B equals 64 (1/4*256). Hence, a determination may be made if fewer than 64 different hash values were generated by performing the hash function on the IP source addresses of the predetermined number of packets, e.g., one thousand packets to be forwarded to the external network. If less than 64 hash values were generated, then an inference may be made that the router may be receiving non-random source addresses. If 64 or greater different hash values were generated, then an inference may be made that the router may be receiving random source addresses.

As stated above, if the number of different hash values generated were less than F*2\hat{ }B, then an inference may be made that the router may be receiving nonrandom source addresses as stated above. Since the router may be receiving nonrandom source addresses, the router may evaluate a higher number of packets up to a maximum number during the next evaluation cycle captured in the steps described above as illustrated in the following equation:

N(i+1)=K*N(i)+(1−K)*MAX

where i is an index of the number of packets to be examined; where N(i+1) is the next number of packets to be examined during the next evaluation cycle; where N(i) is the predetermined number of packets in the evaluation cycle just completed; where K is a constant between the values of 0 and 1; and where MAX is a maximum number of packets to be examined.

For example, if the router examined one thousand packets in the examination cycle just completed (N(i)=1,000) and K=1/2 and MAX=2,000, then the next number of packets to be examined during the next evaluation cycle (N(i+1)) equals 1,500.

Upon determining the next number of packets to be examined during the next evaluation cycle, the router may start the next evaluation cycle by receiving an IP packet as described above.

If, however, the number of different hash values generated were greater than or equal to F*2\hat{ }B, then an inference may be made that the router may be receiving random source addresses. If the number of different hash values generated were greater than or equal to F*2\hat{ }B, then a determination may be made as to whether the number of packets examined in the examination cycle just completed (N(i)) is less than or equal to predetermined threshold. If the number of packets examined in the examination cycle just completed (N(i)) is less than or equal to the predetermined threshold, then a denial-of-service attack may be detected. This may occur when a high percentage of entries in the table are marked as occupied versus the total number of entries in the table based on a given number of packets examined. That is, by generating a high number of different hash values for a given number of received packets, it may provide strong evidence of the router receiving random IP source addresses within a short period of time. Receiving random IP source addresses within a short period of time may be indicative of a denial-of-service attack.

However, if the number of packets examined in the examination cycle just completed (N(i)) exceeds the predetermined threshold, then the router may evaluate a lower number of packets during the next evaluation cycle as illustrated in the following equation:

N(i+1)=K*N(i)

where i is an index of the number of packets to be examined; where N(i+1) is the next number of packets to be examined during the next evaluation cycle; where K is a constant between the values of 0 and 1; and where N(i) is the predetermined number of packets in the evaluation cycle just completed.

The router may examine a lower number of packets during the next examination cycle in order to ensure that the router is receiving random source addresses from a denial-of-service attack and not detecting randomness from normal traffic. For example, if the router examined one thousand packets in the examination cycle just completed (N(i)=1,000) and K=1/2, then the next number of packets to be examined (N(i+1)) equals 500.

Upon determining the next number of packets to be examined during the next evaluation cycle, the router may start the next evaluation cycle by receiving an IP packet as described above.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates an embodiment of a client in the network system configured in accordance with the present invention;

FIG. 3 illustrates an embodiment of a network device in the network system that may be subject to a denial-of-service attack in accordance with the present invention;

FIG. 4 illustrates an embodiment of a router at the edge of a subnet in accordance with the present invention; and

FIG. 5 is a flowchart of a method for detecting a denial-of-service attack in accordance with the present invention.

### DETAILED DESCRIPTION

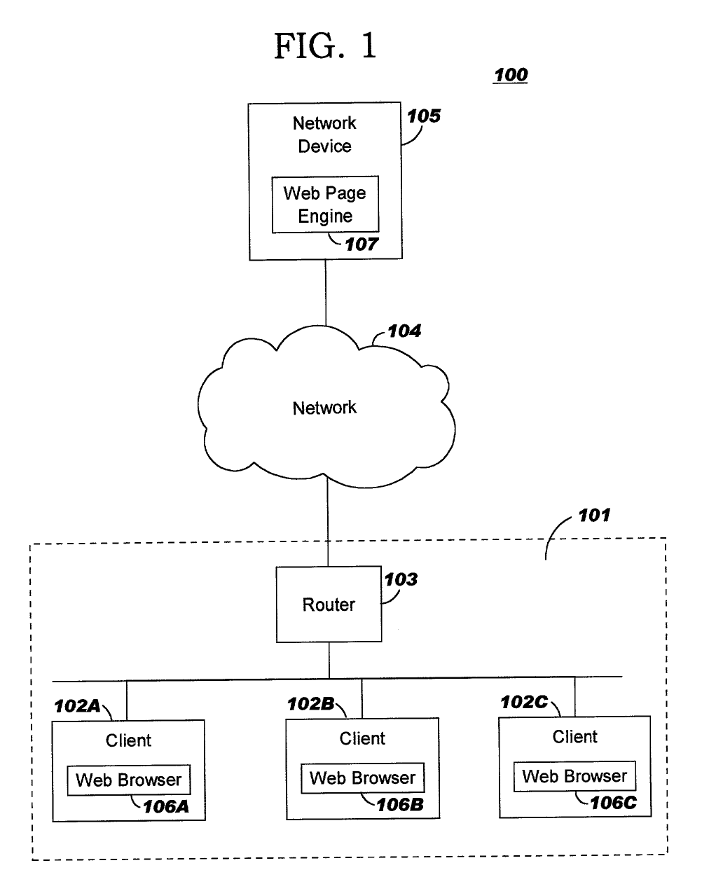

FIG. 1—Network System

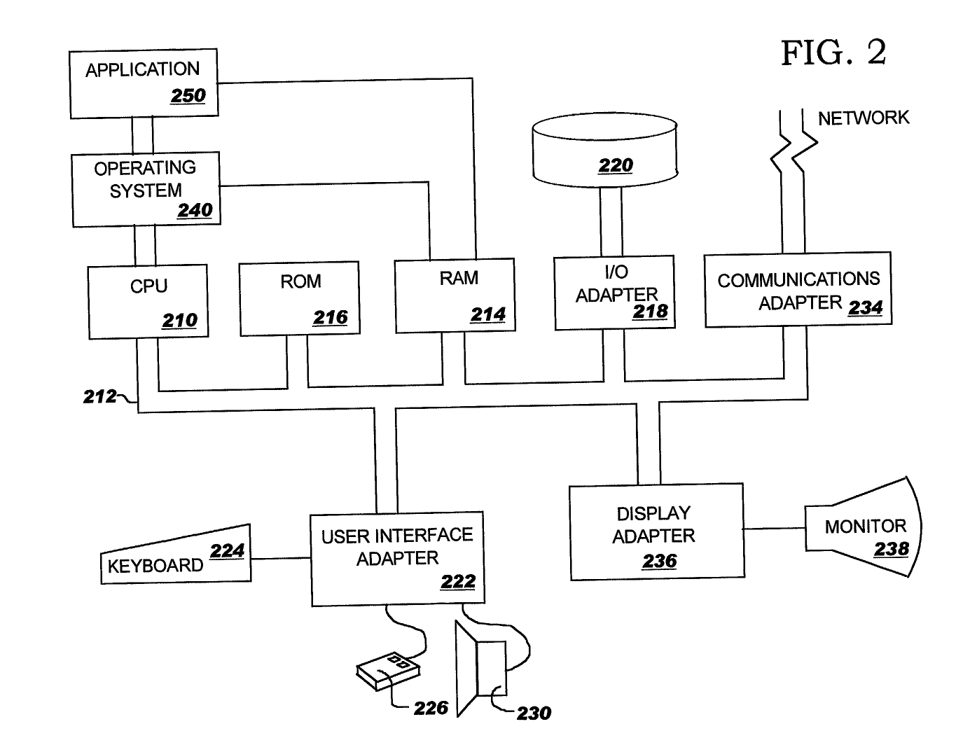

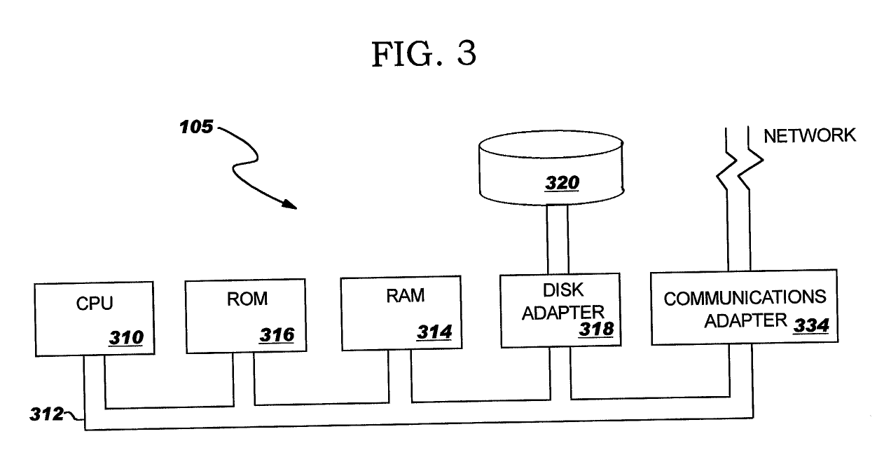

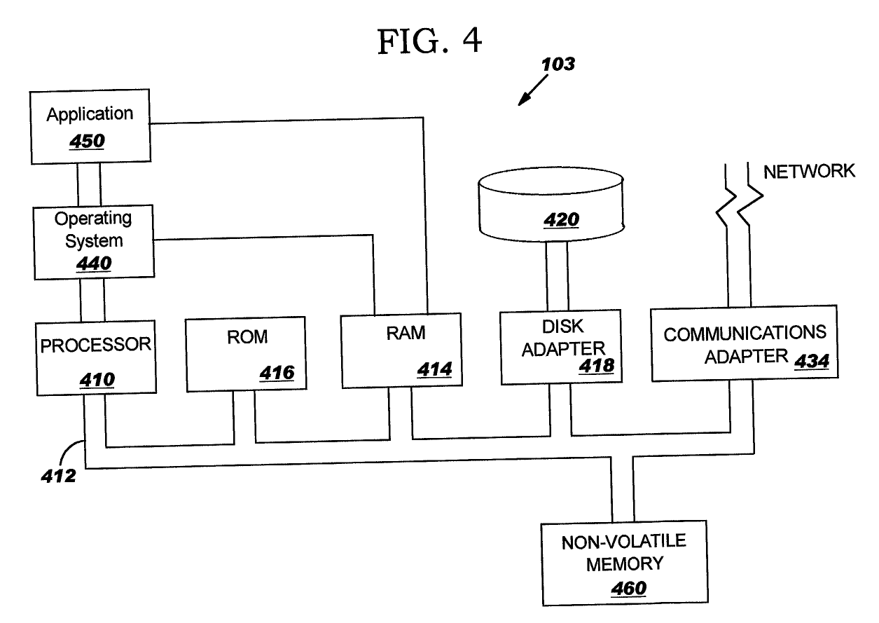

FIG. 1 illustrates an embodiment of a network system 100 in accordance with the present invention. Network system 100 may be divided into multiple subnets 101 where each subnet 101, e.g., Local Area Network (LAN), may be an interconnected, but independent, segment or domain of network system 100. Subnet 101 may comprise one or more clients 102A-C coupled to one or more routers 103 located at the edge of subnet 101. Clients 102A-C may collectively or individually be referred to as clients 102 or client 102, respectively. A more detailed description of client 102 is provided below in conjunction with FIG. 2. A more detailed description of router 103 is provided further below in conjunction with FIG. 4. Router 103 may be coupled to an external network 104. External network 104 may be a LAN, e.g., Ethernet, Token Ring, ARCnet, or a Wide Area Network (WAN), e.g., Internet. External network 104 may be coupled to a network device 105, e.g., web server, server in a server farm, that may be subject to a denial-of-service attack. A more detailed description of network device 105 is provided further below in conjunction with FIG. 3. It is noted that network system 100 may comprise any number of subnets 101 where each subnet 101 may comprise any number of routers 103 and clients 102. It is further noted that the connection between clients 102 and router 103 may be any medium type, e.g., wireless, wired. It is further noted that client 102 may be any type of device, e.g., wireless, Personal Digital Assistant (PDA), portable computer system, cell phone, personal computer system, workstation, Internet appliance, configured with the capability of connecting to network 104 and consequently communicating with network device 105. It is further noted that network system 100 may be any type of system that has at least one client 102, at least one router 103, an external network 104 and a network device 105 subject to a denial-of-service attack. It is further noted that network system 100 is not to be limited in scope to any one particular embodiment.

Referring to FIG. 1, each client 102A-C may comprise a web browser 106A-C, respectively, which may be configured for communicating with network 104, e.g., Internet, and for reading and executing web pages. Browsers 106A-C may collectively or individually be referred to as browsers 106 or browser 106, respectively. While the illustrated client engine is a web browser 106, those skilled in the art will recognize that other client engines may be used in accordance with the present invention.

Network device 105, e.g., web server, may comprise a web page engine 107 for maintaining and providing access to an Internet web page which is enabled to forward static web pages to web browser 106 of client 102. Web pages are typically formatted as a markup language file, for example, using HyperText Markup Language (HTML) or Extended Markup Language (XML) technologies.

FIG. 2—Hardware Configuration of Client

FIG. 2 illustrates a typical hardware configuration of client 102 which is representative of a hardware environment for practicing the present invention. Client 102 may have a central processing unit (CPU) 210 coupled to various other components by system bus 212. An operating system 240, may run on CPU 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, web browser 106. Read-Only Memory (ROM) 216 may be coupled to system bus 212 and include a basic input/output system (“BIOS”) that controls certain basic functions of client 102. Random access memory (RAM) 214 and Input/Output (I/O) adapter 218 may also coupled to system bus 212. It should be noted that software components including operating system 240 and application 250 may be loaded into RAM 214 which may be the computer system's main memory for execution. I/O adapter 218 may be a small computer system interface (“SCSI”) adapter that communicates with a disk unit 220, e.g., disk drive. It is noted that web browser 106 may reside in disk unit 220 or in application 250.

Referring to FIG. 2, client 102 may further comprise a communications adapter 234 coupled to bus 212. Communications adapter 234 may enable client 102 to communicate with router 103 (FIG. 1) and network device 105 (FIG. 1). I/O devices may also be connected to system bus 212 via a user interface adapter 222 and a display adapter 236. Keyboard 224, mouse 226 and speaker 230 may all be interconnected to bus 212 through user interface adapter 222. Event data may be inputted to client 102 through any of these devices. A display monitor 238 may be connected to system bus 212 by display adapter 236. In this manner, a user is capable of inputting, e.g., issuing requests to read web pages, initiating a distributed denial-of-service attack by installing a small attack daemon on other client machines, to client 102 through keyboard 224 or mouse 226 and receiving output from client 102 via display 238.

FIG. 3—Hardware Configuration of Network Device

FIG. 3 illustrates an embodiment of the present invention of network device 105. Referring to FIG. 3, network device 105 may comprise a processor 310 coupled to various other components by system bus 312. Read-Only Memory (ROM) 316 may be coupled to system bus 312 and include a basic input/output system (“BIOS”) that controls certain basic functions of network device 105. Random access memory (RAM) 314, disk adapter 318 and communications adapter 334 may also be coupled to system bus 312. RAM 312 may be network device's 105 main memory for execution. Disk adapter 318 may be a small computer system interface (“SCSI”) adapter that communicates with disk units 320, e.g., disk drive. Communications adapter 334 may interconnect bus 312 with network 104 enabling network device 105 to communicate with router 103 (FIG. 1) and client 102 (FIG. 1).

FIG. 4—Hardware Configuration of Router

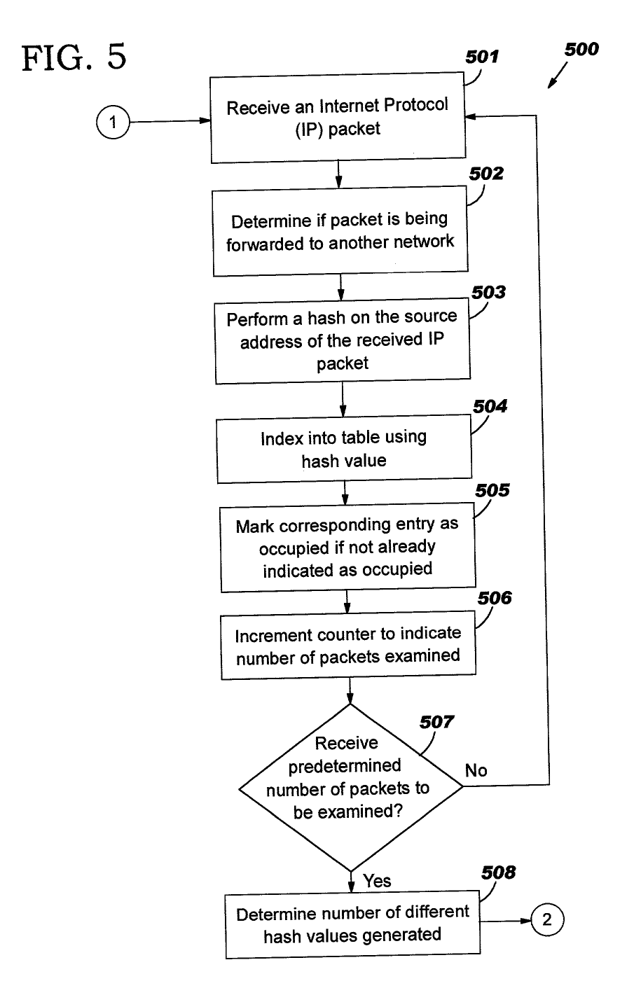

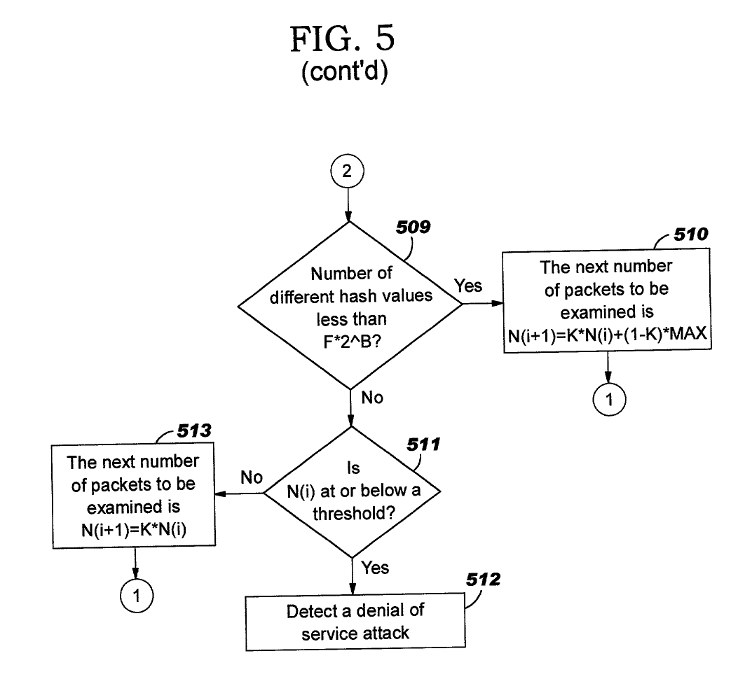

FIG. 4 illustrates an embodiment of the present invention of router 103. Referring to FIG. 4, router 103 may comprise a processor 410 coupled to various other components by system bus 412. An operating system 440, may run on processor 410 and provide control and coordinate the functions of the various components of FIG. 4. An application 450 in accordance with the principles of the present invention may run in conjunction with operating system 440 and provide calls to operating system 440 where the calls implement the various functions or services to be performed by application 450. Application 450 may include, for example, a program for detecting a denial-of-service attack as described in FIG. 5. Read-Only Memory (ROM) 416 may be coupled to system bus 412 and include a basic input/output system (“BIOS”) that controls certain basic functions of router 103. Random access memory (RAM) 414, disk adapter 418 and communications adapter 434 may also be coupled to system bus 412. It should be noted that software components including operating system 440 and application 450 may be loaded into RAM 414 which may be the router's 103 main memory for execution. Disk adapter 418 may be a small computer system interface (“SCSI”) adapter that communicates with a disk unit 420, e.g., disk drive. It is noted that the program of the present invention that detects a denial-of-service attack, as described in FIG. 5, may reside in disk unit 420 or in application 450. Communications adapter 434 may interconnect bus 412 with network 104 enabling router 103 to communicate with network device 105 (FIG. 1) and client 102 (FIG. 1). Router 103 may further comprise a nonvolatile memory 460 coupled to bus 412. Non-volatile memory 460 may be configured to store an Address Resolution Protocol (ARP) table containing a listing of Internet Protocol (IP) addresses associated with Media Access Control (MAC) addresses. Non-volatile memory 460 may further be configured to store a hash table as described in greater detail in conjunction with FIG. 5. It is noted that the ARP and hash tables may be stored in ROM 416, e.g., flash ROM, disk unit 420. It is further noted that the ARP and hash tables may be stored in other storage units not illustrated and that such storage units would be known to a person of ordinary skill in the art. It is further noted that such storage units would fall within the scope of the present invention.

Implementations of the invention include implementations as a computer system programmed to execute the method or methods described herein, and as a computer program product. According to the computer system implementations, sets of instructions for executing the method or methods are resident in RAM 414 of one or more computer systems configured generally as described above. Until required by router 103, the set of instructions may be stored as a computer program product in another computer memory, for example, in disk drive 420 (which may include a removable memory such as an optical disk or floppy disk for eventual use in disk drive 420). Furthermore, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 5—Method for Detecting a Denial-of-Service Attack

FIG. 5 is a flowchart of one embodiment of the present invention of a method 500 for detecting a denial-of-service attack. As stated in the Background Information section, currently, there are no technological means for statistically detecting a denial-of-service attack. However, since attackers commonly spoof the source IP address field to conceal the location of the attacking client, a denial-of-service attack may be observed by determining the randomness of the source IP addresses received. Spoofing may refer to replacing the source address of the sender with a random source IP address thereby concealing the location of the attacker. It would therefore be desirable to detect the randomness in Internet Protocol (IP) source addresses in order to detect a denial-of-service attack. It is noted that the assumption of randomness in the IP source address field of packets in some denial-of-service attacks was verified in the research paper entitled “Inferring Internet Denial-of-Service Activity” by David Moore, et al. Method 500 is a method for detecting the randomness in IP source addresses in order to detect a denial-of-service attack.

Referring to FIG. 5, in conjunction with FIGS. 1 and 4, in step 501, router 103 may receive an Internet Protocol (IP) packet of data from client 102 within subnet 101 or externally from subnet 101. For example, a TCP SYN (Transmission Control Protocol SYNchronize) IP packet may be transmitted to router 103 by web browser 106 of client 102 either within subnet 101 or externally from subnet 101 to establish a TCP connection with network device 105, e.g., server. As stated in the Background Information section, an attacker may install a small attack daemon on client 102, e.g., client 102A, thereby producing a “zombie” client. This daemon typically contains both the code for sourcing a variety of attacks and some basic communications infrastructure to allow for remote control. The attacker may conceal its location by forging or “spoofing” the Internet Protocol (IP) source address of each packet they send. Consequently, the packets appear to the victim network device 105, e.g., server, to be arriving from one or more third parties. For example, in a distributed denial-of-service attack using the SYN flood attack, as discussed in the Background Information section, the attacker may transmit a series of SYN packets to the victim 105, e.g., server, using a series of random spoofed source addresses. Hence, the IP packet received by router 103 may contain a random spoofed source address.

In step 502, it may be determined by router 103 if the received packet is being forwarded to network 104 outside subnet 101. That is, it may be determined if the received packet is being forwarded to another network 104. In one embodiment, it may be determined if the received packet is being forwarded to another network 104 by reading the Media Access Control (MAC) address stored in the packet header. The MAC address may be stored in particular bit positions in the packet header. Upon reading the MAC address, router 103 may perform a look-up in an Address Resolution Protocol (ARP) table configured to store a listing of Internet Protocol (IP) addresses with associated MAC addresses. If the MAC address is listed in the ARP table, then the received packet may have a destination within subnet 101, e.g., client 102 transmitted IP packet to another client 102 in subnet 101. If the MAC address is not listed in the ARP table, then the received packet may have a destination outside subnet 101. That is, if the MAC address is not listed in the ARP table, then the received packet may be determined to be forwarded to network 104 outside subnet 101.

In another embodiment, it may be determined if the received packet is being forwarded to another network 104 by router 103 reading the Time-To-Live (TTL) value stored in the packet header. The TTL value may refer to the number of hops left before the packet may be discarded. Typically, IP packets have an initial TTL value of 16. After each hop, the TTL value is decremented by one. When the TTL value becomes zero, the IP packet may be discarded. Hence, if the TTL value is 16, then it may be assumed that the packet may have a destination within subnet 101, e.g., client 102 transmitted the IP packet to another client 102 in subnet 101. If the TTL value is less than 16, then it may be assumed that the packet was transmitted from outside subnet 101 and have a destination outside subnet 101. That is, if the TTL value is less than 16, then it may be assumed that the received packet is to be forwarded to network 104 outside subnet 101.

For received IP packets that are determined to be forwarded to network 104 outside subnet 101, the following steps 503-507 may occur for each received IP packet to be forwarded to network 104 outside subnet 101.

In step 503, router 103 may perform a hash function on the source address, e.g., 32-bits long, of the received IP packet to generate a hash value, e.g., 8-bit value. In one embodiment, router 103 may extract and concatenate the IP source address and IP source port (if it exists) from the packet header of the received IP packet. The concatenation of the two fields may then be inputted to the hash function to generate a hash value. In one embodiment, the hash function may be a function that transforms a subset of the source address to a hash value if the number n bits of the source address, e.g., most significant bits of the source address, is greater than or equal to the number m bits, e.g., number of bits of the hash value. Hence, the hash value may equal n bits of the source address, e.g., hash value may equal the most significant bits of the source address. Furthermore, the hash function may not necessarily change the order of the n bits of the source address in transforming the n bits of the source address to the m bits of the hash value.

In step 504, the hash value may be indexed into a table or associative array where each entry may correspond to a particular hash value. In step 505, the corresponding entry in the table or associative array may be marked as occupied, e.g., a “1” bit value may be stored, if the entry is not already marked as occupied. An unoccupied entry may store the complement of the value stored in entries marked as occupied. In step 506, a counter, which may be implemented in either software or hardware in router 103, may be incremented by one to indicate the number of packets examined.

In step 507, a determination may be made as to whether the predetermined number of packets, e.g., one thousand packets to be forwarded to external network 104, has been examined. In one embodiment, whether the predetermined number of packets has been examined may be determined by the value of the counter as described above. If less than the predetermined number of packets has been examined, then router 103 may receive another IP packet of data in step 501.

If the predetermined number of packets, e.g., one thousand packets to be forwarded to external network 104, has been examined by router 103, then router 103, in step 508, may determine the number of different hash values generated from performing the hash function on the IP source addresses of the predetermined number of packets. In one embodiment, the number of different hash values generated from performing the hash function on the IP source addresses of the predetermined number of packets may be determined by counting the number of entries in the table marked as being occupied.

In step 509, a determination may be made as to whether the number of different hash values generated is less than the following:

F*2\hat{ }B

where F is a predetermined fraction, e.g., ¼, and B is a number of bits of the hash value, e.g., 8-bits.

For example, if F has a value of 1/2 and the hash values generated by the hash function in step 503 were 8-bits long, then F*2\hat{ }B equals 64 (1/4*256). Hence, a determination may be made if fewer than 64 different hash values were generated by performing the hash function on the IP source addresses of the predetermined number of packets, e.g., one thousand packets to be forwarded to external network 104. If less than 64 hash values were generated, then an inference may be made that router 103 may be receiving non-random source addresses. If 64 or greater different hash values were generated, then an inference may be made that router 103 may be receiving random source addresses.

For example, if the length of the hash values generated in step 503 were 8-bits long, then there are a total possible 2\hat{ }8 (256) different hash values that may be generated. Each hash value may be able to index into a particular entry in a table. Hence, the table may comprise 256 entries where each entry may correspond to a particular hash value. If 200 different hash values were generated by performing the hash function on the IP source addresses of the predetermined number of packets, e.g., one thousand packets to be forwarded to external network 104, then 200 out of the 256 entries in the table are marked as being occupied. Since the percentage of entries marked versus the total number of entries in the table is high, it may be indicative of receiving random IP source addresses. That is, since a large number of different hash values were generated, it may be indicative of receiving random IP source addresses. If the percentage of entries marked versus the total number of entries in the table were low, then it may be indicative of receiving non-random IP source addresses. That is, since a small number of different hash values were generated, it may be indicative of receiving non-random IP source addresses. The determination of whether router 103 may be receiving random or non-random IP source addresses may be captured in the formula F*2\hat{ }B as discussed above.

Referring to step 509, if the number of different hash values generated were less than F*2\hat{ }B, then an inference may be made that router 103 may be receiving non-random source addresses as stated above. Since router 103 may be receiving non-random source addresses, router 103 may evaluate a higher number of packets up to a maximum number during the next evaluation cycle captured in steps 501-507 as illustrated in the following equation:

N(i+1)=K*N(i)+(1−K)*MAX (EQ1)

where i is an index of the number of packets to be examined; where N(i+1) is the next number of packets to be examined during the next evaluation cycle; where N(i) is the predetermined number of packets in the evaluation cycle just completed; where K is a constant between the values of 0 and 1; and where MAX is a maximum number of packets to be examined.

For example, if router 103 examined one thousand packets in the examination cycle just completed (N(i)=1,000) and K=1/2 and MAX=2,000, then the next number of packets to be examined during the next evaluation cycle (N(i+1)) equals 1,500. Hence, router 103 will examine one thousand five hundred packets during the next examination cycle as discussed above in steps 501-507.

Upon determining the next number of packets to be examined during the next evaluation cycle, router 103 may start the next evaluation cycle by receiving an IP packet in step 501.

Referring to step 509, if the number of different hash values generated were greater than or equal to F*2\hat{ }B, then an inference may be made that router 103 may be receiving random source addresses. If the number of different hash values generated were greater than or equal to F*2\hat{ }B, then a determination may be made in step 511 as to whether the number of packets examined in the examination cycle just completed (N(i)) is less than or equal to a predetermined threshold. If the number of packets examined in the examination cycle just completed (N(i)) is less than or equal to the predetermined threshold, then a denial-of-service attack may be detected in step 512. This may occur when a high percentage of entries in the table are marked as occupied versus the total number of entries in the table based on a small number of packets examined. That is, by generating a high number of different hash values for a small number of received packets, it may provide strong evidence of router 103 receiving random IP source addresses within a short period of time. Receiving random IP source addresses within a short period of time may be indicative of a denial-of-service attack.

Referring to step 511, if the number of packets examined in the examination cycle just completed (N(i)) exceeds the predetermined threshold, then router 103, in step 513, may evaluate a lower number of packets during the next evaluation cycle as illustrated in the following equation:

N(i+1)=K*N(i) (EQ2)

where i is an index of the number of packets to be examined; where N(i+1) is the next number of packets to be examined during the next evaluation cycle; where K is a constant between the values of 0 and 1; and where N(i) is the predetermined number of packets in the evaluation cycle just completed.

Router 103 may examine a lower number of packets during the next examination cycle in order to ensure that router 103 is receiving random source addresses from a denial-of-service attack and not detecting randomness from normal traffic. For example, if router 103 examined one thousand packets in the examination cycle just completed (N(i)=1,000) and K=1/2, then the next number of packets to be examined (N(i+1)) equals 500. Hence, router 103 will examine five hundred packets during the next examination cycle as discussed above in steps 501-507.

Upon determining the next number of packets to be examined during the next evaluation cycle, router 103 may start the next evaluation cycle by receiving an IP packet in step 501.

It is noted that method 500 may be executed in a different order presented and that the order presented in the discussion of FIG. 5 is illustrative. It is further noted that certain steps in FIG. 5 may be executed almost concurrently.

Although the system, computer program product and method are described in connection with several embodiments, it is not intended to be limited to the specific forms set forth herein; but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for detecting a denial-of-service attack comprising the steps of:
receiving a packet of data to be forwarded to another network;
performing a hash function on a source address of said packet of data generating a hash value; and
determining a number of different hash values generated from performing said hash function on source addresses of a predetermined number of packets to be forwarded to another network, wherein if said number of different hash values is greater than or equal to a predetermined value then the method further comprises the step of:
determining if said predetermined number of packets is at or below a threshold, wherein if said predetermined number of packets is at or below said threshold then said denial-of-service attack is detected.

2. The method as recited in claim 1 further comprising the steps of:
indexing into a table using said hash value generated;
marking an entry in said table corresponding to said hash value generated as occupied if not already indicated as occupied; and
incrementing a counter to indicate a number of packets examined.

3. The method as recited in claim 1, wherein if said number of different hash values in said table is less than said predetermined value then the method further comprises the step of:
examining a next number of packets to be forwarded to another network, wherein said next number of packets to be examined is determined by:
N(i+1)=K*N(i)+(1−K)*MAX,
wherein i is an index of a number of packets to be examined;
wherein N(i+1) is said next number of packets to be examined;
wherein N(i) is said predetermined number of packets;
wherein K is a constant; and
wherein MAX is a maximum number of packets to be examined.

4. The method as recited in claim 1, wherein if said predetermined number of packets is greater than said threshold then the method further comprises the step of:
examining a next number of packets to be forwarded to another network, wherein said next number of packets to be examined is determined by:
N(i+1)=K*N(i),
wherein i is an index of a number of packets to be examined;
wherein N(i+1) is said next number of packets to be examined;
wherein N(i) is said predetermined number of packets; and
wherein K is a constant.

5. The method as recited in claim 1, wherein said predetermined value is equal to:
F*2\hat{ }B,
wherein F is a predetermined fraction; and
wherein B is a number of bits of said hash value.

6. A computer program product embodied in a machine readable medium for detecting a denial-of-service attack comprising the programming steps of:
receiving a packet of data to be forwarded to another network;
performing a hash function on a source address of said packet of data generating a hash value; and
determining a number of different hash values generated from performing said hash function on source addresses of a predetermined number of packets to be forwarded to another network, wherein if said number of different hash values is greater than or equal to a predetermined value then the computer program product further comprises the programming step of:
determining if said predetermined number of packets is at or below a threshold, wherein if said predetermined number of packets is at or below said threshold then said denial-of-service attack is detected.

7. The computer program product as recited in claim 6 further comprising the programming steps of:
indexing into a table using said hash value generated;
marking an entry in said table corresponding to said hash value generated as occupied if not already indicated as occupied; and
incrementing a counter to indicate a number of packets examined.

8. The computer program product as recited in claim 6, wherein if said number of different hash values in said table is less than said predetermined value then the computer program product further comprises the programming step of:
examining a next number of packets to be forwarded to another network, wherein said next number of packets to be examined is determined by:
N(i+1)=K*N(i)+(1−K)*MAX,
wherein i is an index of a number of packets to be examined;
wherein N(i+1) is said next number of packets to be examined;
wherein N(i) is said predetermined number of packets;
wherein K is a constant; and
wherein MAX is a maximum number of packets to be examined.

9. The computer program product as recited in claim 6, wherein if said predetermined number of packets is greater than said threshold then the computer program product further comprises the programming step of:
examining a next number of packets to be forwarded to another network, wherein said next number of packets to be examined is determined by:
N(i+1)=K*N(i),
wherein i is an index of a number of packets to be examined;
wherein N(i+1) is said next number of packets to be examined;
wherein N(i) is said predetermined number of packets; and
wherein K is a constant.

10. The computer program product as recited in claim 6, wherein said predetermined value is equal to:
F*2\hat{ }B,
wherein F is a predetermined fraction; and
wherein B is a number of bits of said hash value.

11. A system, comprising:
a memory unit operable for storing a computer program operable for detecting a denial-of-service attack; and
a processor coupled to said memory unit, wherein said processor, responsive to said computer program, comprises:
circuitry operable for receiving a packet of data to be forwarded to another network;
circuitry operable for performing a hash function on a source address of said packet of data generating a hash value; and
circuitry operable for determining a number of different hash values generated from performing said hash function on source addresses of a predetermined number of packets to be forwarded to another network, wherein if said number of different hash values is greater than or equal to a predetermined value then said processor further comprises:
circuitry operable for determining if said predetermined number of packets is at or below a threshold, wherein if said predetermined number of packets is at or below said threshold then said denial-of-service attack is dedected.

12. The system as recited in claim 11, wherein said processor further comprises:
circuitry operable for indexing into a table using said hash value generated;
circuitry operable for marking an entry in said table corresponding to said hash value generated as occupied if not already indicated as occupied; and
circuitry operable for incrementing a counter to indicate a number of packets examined.

13. The system as recited in claim 11, wherein if said number of different hash values in said table is less than said predetermined value then said processor further comprises:
circuitry operable for examining a next number of packets to be forwarded to another network, wherein said next number of packets to be examined is determined by:
N(i+1)=K*N(i)+(1−K)*MAX,
wherein i is an index of a number of packets to be examined;
wherein N(i+1) is said next number of packets to be examined;
wherein N(i) is said predetermined number of packets;
wherein K is a constant; and
wherein MAX is a maximum number of packets to be examined.

14. The system as recited in claim 11, wherein if said predetermined number of packets is greater than said threshold then said processor further comprises:
circuitry operable for examining a next number of packets to be forwarded to another network, wherein said next number of packets to be examined is determined by:
N(i+1)=K*N(i),
wherein i is an index of a number of packets to be examined;
wherein N(i+1) is said next number of packets to be examined;
wherein N(i) is said predetermined number of packets; and
wherein K is a constant.

15. The system as recited in claim 11, wherein said predetermined value is equal to:
F*2\hat{ }B,
wherein F is a predetermined fraction; and
wherein B is a number of bits of said hash value.

16. A system, comprising:
a router coupled to an external network, wherein said router is configured to forward packets of data issued from one or more clients to said external network, wherein said router comprises:
a memory unit operable for storing a computer program operable for detecting a denial-of-service attack; and
a processor coupled to said memory unit, wherein said processor, responsive to said computer program, comprises:
circuitry operable for receiving a packet of data to be forwarded to another network;
circuitry operable for performing a hash function on a source address of said packet of data generating a hash value; and
circuitry operable for determining a number of different hash values generated from performing said hash function on source addresses of a predetermined number of packets to be forwarded to another network, wherein if said number of different hash values is greater than or equal to a predetermined value then said processor further comprises:
circuitry operable for determining if said predetermined number of packets is at or below a threshold, wherein if said predetermined number of packets is at or below said threshold then said denial-of-service attack is detected.

17. The system as recited in claim 16, wherein said processor further comprises:
circuitry operable for indexing into a table using said hash value generated;
circuitry operable for marking an entry in said table corresponding to said hash value generated as occupied if not already indicated as occupied; and
circuitry operable for incrementing a counter to indicate a number of packets examined.

18. The system as recited in claim 16, wherein if said number of different hash values in said table is less than said predetermined value then said processor further comprises:
circuitry operable for examining a next number of packets to be forwarded to another network, wherein said next number of packets to be examined is determined by:
N(i+1)=K*N(i)+(1−K)*MAX,
wherein i is an index of a number of packets to be examined;
wherein N(i+1) is said next number of packets to be examined;
wherein N(i) is said predetermined number of packets;
wherein K is a constant; and
wherein MAX is a maximum number of packets to be examined.

19. The system as recited in claim 16, wherein if said predetermined number of packets is greater than said threshold then said processor further comprises:
circuitry operable for examining a next number of packets to be forwarded to another network, wherein said next number of packets to be examined is determined by:
N(i+1)=K*N(i),
wherein i is an index of a number of packets to be examined;
wherein N(i+1) is said next number of packets to be examined;
wherein N(i) is said predetermined number of packets; and
wherein K is a constant.

20. The system as recited in claim 16, wherein said predetermined value is equal to:
F*2\hat{ }B,
wherein F is a predetermined fraction; and
wherein B is a number of bits of said hash value.
